(19) United States
(12) Patent Application Publication
(10) Pub. No.: US 2025/0076724 A1
(43) Pub. Date: Mar. 6, 2025

(54) TOUCH DISPLAY APPARATUS

(71) Applicant: TPK Touch Solutions (Xiamen) Inc., Xiamen, Fujian (CN)

(72) Inventors: Feng-Cheng Hsu, Taipei City (TW); An-Lun Han, Taipei City (TW); Chien-Min Lai, Taipei City (TW); Min-Yih Cheng, Taipei City (TW)

(21) Appl. No.: 18/754,344

(22) Filed: Jun. 26, 2024

(30) Foreign Application Priority Data
Sep. 4, 2023 (CN) 202311132100.5

(51) Int. Cl. G02F 1/16756; G02F 1/167; G02F 1/1677; G06F 3/041; G06F 3/044

(52) U.S. Cl. CPC G02F 1/16756; G02F 1/167; G02F 1/1677; G06F 3/0412; G06F 3/0443

(57) ABSTRACT

A touch display apparatus comprises an electrophoretic structure, a protective layer, and at least one touch sensing layer. The protective layer is disposed on the electrophoretic structure and comprises an organic material layer and an inorganic material layer. The inorganic material layer is located between the electrophoretic structure and the organic material layer. The material of the inorganic material layer comprises silicon dioxide (SiO₂). The thickness of the inorganic material layer is from 20 nm to 400 nm. The touch sensing layer is disposed on one side of the protective layer.

### CROSS-REFERENCE TO RELATED APPLICATION

The instant application claims priority to China Patent Application 202311132100.5, filed on Sep. 4, 2023, which is incorporated herein by reference.

### BACKGROUND OF THE DISCLOSURE

### Field of Disclosure

The present disclosure relates to a display apparatus, especially a touch display apparatus.

### Description of Related Art

With the rapid development of display technology, various novel display apparatuses have been developed; electrophoretic display apparatuses have advantageous features such as low power consumption and flexibility, thereby having great development potential. Conventional electrophoretic display apparatuses are typically controlled by a physical button on a housing. The physical button occupies the surface area of the display apparatus, which hinders the electrophoretic display apparatus from reducing its size.

Therefore, touch electrophoretic display apparatuses, which can be controlled by touching the screen of the electrophoretic display apparatus, have been developed by some manufacturers. In general, a touch electrophoretic display apparatus comprises an electrophoretic structure, a protective layer, and a touch sensing module. The protective layer covers the electrophoretic structure; the touch sensing module is adhered onto the protective layer. For example, a variety of stacked layer structures of touch sensing modules and protective layers are disclosed by Taiwan, R.O.C. Patent Publication No. I554918.

Nevertheless, electrophoretic display apparatuses currently available do not have any effective waterproof feature to prevent the electrophoretic structure from the impact of moisture. As a result, the product lifetime of electrophoretic display apparatus becomes shorter.

Therefore, how to introduce a solution that can solve the aforementioned problems of touch display apparatuses is what the industry invests its research and development resources in and intends to achieve.

### SUMMARY

In view of the aforementioned problems, the objective of the present disclosure is to provide solutions for touch display apparatuses of related art.

In accordance with one embodiment of the present disclosure, in order to achieve the aforementioned objective, a touch display apparatus comprises an electrophoretic structure, a protective layer, and at least one touch sensing layer. The protective layer is disposed on the electrophoretic structure and comprises an organic material layer and an inorganic material layer. The inorganic material layer is located between the electrophoretic structure and the organic material layer. A material of the inorganic material layer comprises silicon dioxide (SiO₂). A thickness of the inorganic material layer is from 20 nm to 400 nm. The at least one touch sensing layer is disposed on one side of the protective layer.

In one or more embodiments of the present disclosure, a material of the organic material layer comprises polyethylene terephthalate (PET), polyimide (PI), polymethyl methacrylate (PMMA), polycarbonate (PC), polyurethane (PU), polyvinyl chloride (PVC), or polycaprolactone (PCL).

In one or more embodiments of the present disclosure, a thickness of the organic material layer is from 700 nm to 10 μm.

In one or more embodiments of the present disclosure, the at least one touch sensing layer comprises a first touch sensing layer and a second touch sensing layer. The first touch sensing layer and the second touch sensing layer are respectively located on two opposite sides of the protective layer.

In one or more embodiments of the present disclosure, the first touch sensing layer is in contact with one surface of the organic material layer away from the inorganic material layer. The second touch sensing layer is in contact with one surface of the inorganic material layer away from the organic material layer.

In one or more embodiments of the present disclosure, the first touch sensing layer comprises a thin film substrate and a sensing electrode layer. The thin film substrate is disposed on one side of the organic material layer, away from the inorganic material layer. The sensing electrode layer is disposed on the thin film substrate and located between the thin film substrate and the organic material layer.

In one or more embodiments of the present disclosure, the touch display apparatus further comprises a cover plate and a light guide plate. The cover plate is disposed on one side of the protective layer, away from the electrophoretic structure. The light guide plate is disposed between the cover plate and the protective layer.

In accordance with one embodiment of the present disclosure, in order to achieve the aforementioned objective, a touch display apparatus comprises an electrophoretic structure, a protective layer, and at least one touch sensing layer. The protective layer is disposed on the electrophoretic structure and comprises an organic material layer and an inorganic material layer. The inorganic material layer is located between the electrophoretic structure and the organic material layer. The touch sensing layer is disposed on one side of the protective layer. A combination of the protective layer and the at least one touch sensing layer has a light transmittance higher than 85% and a water vapor transmission rate (WVTR) less than 0.01 g/m²·day at 50 degrees Celsius (° C.).

In one or more embodiments of the present disclosure, a material of the organic material layer comprises polyethylene terephthalate (PET), polyimide (PI), polymethyl methacrylate (PMMA), polycarbonate (PC), polyurethane (PU), polyvinyl chloride (PVC), or polycaprolactone (PCL).

In one or more embodiments of the present disclosure, a material of the inorganic material layer comprises aluminum oxide (AlOₓ), silicon oxide (SiOₓ), silicon nitride, titanium oxide, zirconium oxide, aluminum oxynitride, silicon oxynitride or amorphous carbon.

In one or more embodiments of the present disclosure, a material of the organic material layer comprises polyethylene terephthalate, and a material of the inorganic material layer comprises silicon dioxide.

In one or more embodiments of the present disclosure, a thickness of the organic material layer is from 700 nm to 10 μm.

In one or more embodiments of the present disclosure, the at least one touch sensing layer comprises a first touch sensing layer and a second touch sensing layer. The first touch sensing layer and the second touch sensing layer are respectively located on two opposite sides of the protective layer.

In one or more embodiments of the present disclosure, the first touch sensing layer is in contact with one surface of the organic material layer, away from the inorganic material layer. The second touch sensing layer is in contact with one surface of the inorganic material layer, away from the organic material layer.

In one or more embodiments of the present disclosure, the first touch sensing layer comprises a thin film substrate and a sensing electrode layer. The thin film substrate is disposed on one side of the organic material layer, away from the inorganic material layer. The sensing electrode layer is disposed on the thin film substrate and located between the thin film substrate and the organic material layer.

In one or more embodiments of the present disclosure, the touch display apparatus further comprises a cover plate and a light guide plate. The cover plate is disposed on one side of the protective layer, away from the electrophoretic structure. The light guide plate is disposed between the cover plate and the protective layer.

In summary, the protective layer, disposed on the electrophoretic structure of the touch display apparatus of the present disclosure is a composite material that comprises an organic material layer and an inorganic material layer, in which the inorganic material layer is closer to the electrophoretic structure than the organic material layer is. Therefore, the protective layer of the present disclosure has at least the following advantages: (1) high resistance to penetration, blocking external moisture effectively; (2) low water content rate, preventing the electrophoretic structure from the impact of water vapor within the material; and (3) low reactivity, not prone to oxidation and reduction (redox) reaction during electrode conversion.

The aforementioned statements are used to explain problems that can be solved by the present disclosure, the technical ways for solving problems, related effects, and so on. The present disclosure will become more fully understood from the detailed descriptions given herein below, by means of embodiments with reference to the attached drawings for illustration.

### BRIEF DESCRIPTION OF THE DRAWINGS

To better understand the aforementioned objective and other objectives, novel features, advantages, embodiments, and the effect of the present disclosure, the relevant diagrams are provided as follows:

FIG. 1 is a schematic diagram of the touch display apparatus of an embodiment of the present disclosure; and

FIG. 2 is a schematic diagram of the touch display apparatus of another embodiment of the present disclosure.

### DETAILED DESCRIPTION

A plurality of embodiments of the present disclosure will be disclosed below with reference to the drawings. For purpose of clear illustration, many details in practice will be provided together with the following descriptions. However, these detailed descriptions in practice are for illustration only, which should not be interpreted to limit the scope, applicability, or configuration of the present disclosure in any way. That is, in some embodiments of the present disclosure, these details in practice are not necessary. Furthermore, for purpose of simplifying the drawings, some structures and components of the prior art shown in the drawings will be illustrated schematically.

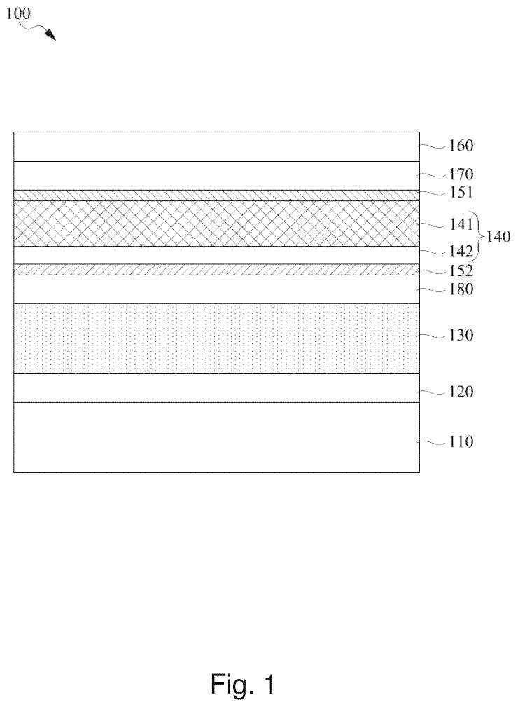

FIG. 1 is a schematic diagram of the touch display apparatus 100 of an embodiment of the present disclosure. As shown in FIG. 1, in one embodiment, the touch display apparatus 100 comprises a substrate 110, a thin film transistor array module (TFT array module) 120, an electrophoretic structure 130, a protective layer 140, a first touch sensing layer 151, a second touch sensing layer 152, and a cover plate 160. The TFT array module 120 is disposed on the substrate 110. The electrophoretic structure 130 is disposed on the TFT array module 120. The TFT array module 120 is configured to create a specific electric field to drive the electrophoretic structure 130. The protective layer 140 is disposed on the electrophoretic structure 130; the protective layer 140 and the TFT array module 120 are respectively located on two opposite sides of the electrophoretic structure 130. The protective layer 140 performs the function of protecting the electrophoretic structure 130. More specifically, the first touch sensing layer 151 is located on one side of the protective layer 140, away from the electrophoretic structure 130; the second touch sensing layer 152 is located between the protective layer 140 and the electrophoretic structure 130. The cover plate 160 is disposed on one side of the protective layer 140, away from the electrophoretic structure 130. The cover plate 160 performs the function of protecting the elements stacked thereunder, to facilitate the user performing touch operations by finger. The first touch sensing layer 151 and the second touch sensing layer 152 can detect the touch operations by finger on the cover plate 160, to generate corresponding outputs of touch signals.

In some embodiments, the electrophoretic structure 130 comprises a plurality of microcapsules (not shown in figures). Each microcapsule has a plurality of light-colored charged particles and a plurality of dark-colored charge particles. The light-colored charged particles and the dark-colored charged particles are the charges of different types. For example, the light-colored charged particles can be negatively charged, and the dark-colored charged particles can be positively charged. When the electrophoretic structure 130 is located in an electric field, the light-colored charged particles and the dark-colored charged particles will move over, due to the influence of the electric field, so as to display a required image.

As shown in FIG. 1, in some embodiments, the protective layer 140 is a composite layer that comprises an organic material layer 141 and an inorganic material layer 142. The inorganic material layer 142 is located between the electrophoretic structure 130 and the organic material layer 141. In other words, the inorganic material layer 142 is closer to the electrophoretic structure 130 than the organic material layer 141 is. The structural configuration of setting the inorganic material layer 142 closer to the electrophoretic structure 130 has at least the following advantages: (1) high resistance to penetration, blocking external moisture effectively; (2) low water content rate, preventing the electrophoretic structure 130 from the impact of water vapor within the material; and (3) low reactivity, not prone to oxidation and reduction (redox) reaction during electrode conversion. For example, the protective layer 140 comprises the organic material layer 141 and the inorganic material layer 142 through this embodiment; the combination of the protective layer 140 and the touch sensing layers in this embodiment can achieve a water vapor transmission rate (WVTR) less than 0.01 g/m²·day at around 50 degrees Celsius (° C.).

In some embodiments of the present disclosure, the material of the organic material layer 141 comprises (but not limited to) polyethylene terephthalate (PET), polyimide (PI), polymethyl methacrylate (PMMA), polycarbonate (PC), polyurethane (PU), polyvinyl chloride (PVC), or polycaprolactone (PCL).

In some embodiments of the present disclosure, the material of the inorganic material layer 142 comprises, but not limited to, aluminum oxide (AlOₓ), silicon oxide (SiOₓ), silicon nitride, titanium oxide, zirconium oxide, aluminum oxynitride, silicon oxynitride, or amorphous carbon.

Table 1 shows the actual test data of water vapor transmission rate (WVTR) of different material or composite.

TABLE 1

| Material or Composite | WVTR (g/m² · day) |
|---|---|
| PET | 3.9-17 |
| PEN | 7.3 |
| PE | 1.2-5.9 |
| PP | 1.2-5.9 |
| PES | 14 |
| PI | 0.4-21 |
| PS | 7.9-40 |
| 15 m Al/PET | 0.18 |
| SiOₓ/PET | 0.001 |

According to the test results listed in Table 1, in a preferred embodiment of the protective layer 140 of the present disclosure, the material of the organic material layer 141 comprises PET; the material of the inorganic material layer 142 comprises silicon dioxide.

Table 2 shows the actual test data of water vapor transmission rate (WVTR) of different products using an organic material of PET.

TABLE 2

| Model No. | Thickness (μm) | WVTR (g/m² · day) |
|---|---|---|
| Toray U483 | 50 | 12.1 |
| Gaoheng JYT-16 | 120 | 6.1 |
| Zacros PC-751 | 55 | 11 |
| Gaoheng CG119E2 | 119 | 6.09 |

According to Table 2, if the protective layer 140 only comprises an organic material layer 141 without the inorganic material layer 142, the protective layer 140 is unable to meet the requirement of a WVTR less than 0.01 g/m²·day. As a result, the protective layer 140 is unable to have the aforementioned advantages of high resistance to penetration, low water content rate, and low reactivity.

On the contrary, if the protective layer 140 only comprises an inorganic material layer 142 without the organic material layer 141, the protective layer 140 has less covering capability and flexibility.

In some embodiments, for instance, the inorganic material layer 142 having the material that comprises silicon dioxide may have a thickness ranging from 10 nm to 800 nm. In some embodiments, the thickness of the organic material layer 141 may range from 500 nm to 50 μm.

Table 3 shows the test results of resistance to water vapor penetration and visibility of composites of a touch sensing layer used together with a protective layer 140 of different thickness, in which the material of the inorganic material layer 142 comprises silicon dioxide.

TABLE 3

| Thickness of the | Thickness of the | |
|---|---|---|
| inorganic material layer | organic material layer | Test Result |
| 10 nm | 700 nm | Fail A |
| 20 nm | 700 nm | Pass |
| 20 nm | 500 nm | Fail A |
| 30 nm | 500 nm | Pass |
| 400 nm | 10 μm | Pass |
| 500 nm | 10 μm | Fail B |
| 400 nm | 15 μm | Fail B |

In Table 3, Fail A indicates that the composite cannot meet the required WVTR, which is less than 0.01 g/m²·day; Fail B means that the composite cannot meet the required light transmittance, which is larger than 85% in visibility. According to Table 3, taking an inorganic material layer 142 comprising material of silicon dioxide as an example, the preferred thickness thereof is from 20 nm to 400 nm in order to maintain a better water vapor transmission rate and roughness. More specifically, when the thickness is larger than 400 nm, the roughness of the inorganic material layer 142 will increase, thereby resulting in the light transmittance decreasing. Therefore, by adjusting the thickness of the inorganic material layer 142, the surface roughness of the organic material layer 141 can be effectively improved while the light transmittance can be enhanced further. According to Table 3, the preferred thickness of the organic material layer 141 is from 700 nm to 10 μm.

In some embodiments, the composite of the protective layer 140 and the touch sensing layer has a light transmittance of less than 3% for wavelength at 380 nm. However, the present disclosure is not limited thereto.

In some embodiments, the composite of the protective layer 140 and the touch sensing layer has a haze which is less than 2.5%. However, the present disclosure is not limited thereto.

In some embodiments, the composite of the protective layer 140 and the touch sensing layer has a clarity of larger than 95%. However, the present disclosure is not limited thereto.

In the embodiment, as shown in FIG. 1, the first touch sensing layer 151 is in contact with one surface of the organic material layer 141 away from the inorganic material layer 142. The second touch sensing layer 152 is in contact with one surface of the inorganic material layer 142 away from the organic material layer 141. The first touch sensing layer 151 and the second touch sensing layer 152 both comprise light-transmissive conductive material (for instance, indium tin oxide (ITO)), or electrode layers via the deposition of silver nano wires (SNW; a.k.a. AgNW). However, the present disclosure is not limited thereto. For example, the light-transmissive conductive material or SNW can be disposed on the protective layer 140 through a printing process. Next, the aforementioned light-transmissive conductive material or SNW is formed into patterns as electrodes on the protective layer 140 through a photolithography process or laser lithography, so as to fabricate the first touch sensing layer 151 and the second touch sensing layer 152. In other words, the protective layer 140 can be regarded as a film layer for disposing the first touch sensing layer 151 and the second touch sensing layer 152 (that is, a film layer shared by the first touch sensing layer 151 and the second touch sensing layer 152).

In some embodiments, the first touch sensing layer 151 comprises a plurality of first axial electrodes separated from one another (not shown in the drawings); the second touch sensing layer 152 comprises a plurality of second axial electrodes separated from one another (not shown in the drawings). The aforementioned “first axis” and “second axis” can be, for example, two axes that are perpendicular to each other (for instance, X-axis and Y-axis). In other words, the first axial electrodes are conductive wires extending along the first axis and spaced apart from each other; the second axial electrodes are conductive wires extending along the second axis and spaced apart from each other.

In some embodiments, the first touch sensing layer 151 and the second touch sensing layer 152 are configured on the same side of the protective layer 140 and are both disposed on the surface of the protective layer 140 away from the electrophoretic structure or disposed on the surface of the protective layer 140 closer to the electrophoretic structure 130. For example, the second axial electrodes of the second touch sensing layer 152 are extended across the first touch sensing layer 151 along the second axis through insulated bridge structures.

In some embodiments, the first touch sensing layer 151 and the second touch sensing layer 152 are made of a metal mesh layer. For example, metal material is disposed on the protective layer 140 through a printing process. Next, the aforementioned metal material is formed into patterns as electrodes through a photolithography process or laser lithography, so as to fabricate the first touch sensing layer 151 and the second touch sensing layer 152.

In the embodiment, as shown in FIG. 1, the touch display apparatus 100 further comprises a light guide plate 170. The light guide plate 170 is disposed between the cover plate 160 and the protective layer 140. The light guide plate 170 is configured to guide the light from the front light source (not shown in the drawings) uniformly toward the electrophoretic structure 130 in order to increase the contrast, readability, and comfort of the touch display apparatus 100. In some other embodiments, the light guide plate 170 can be omitted.

In the embodiment, as shown in FIG. 1, the touch display apparatus 100 further comprises a color filter 180. The color filter 180 is disposed on a side of the electrophoretic structure 130 facing the protective layer 140. The color filter 180 is configured to convert the black and white colors, displayed by the dark-colored and light-colored charged particles, into various colors. The color filter 180 comprises three layers of red, green, and blue colors separately. When the electric current passes through the electrophoretic structure 130, the color filter 180 will block unnecessary colors and only allow necessary colors to pass through. In this process, the objective of having the touch display apparatus 100 display colorful images and texts can be achieved. In some other embodiments, the color filter 180 can be omitted.

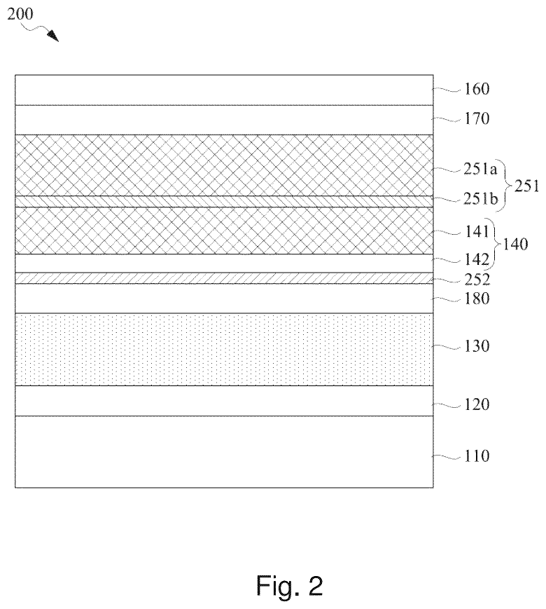

Please refer to FIG. 2. FIG. 2 is a schematic diagram of the touch display apparatus 200 of another embodiment of the present disclosure. In the embodiment; as shown in FIG. 2, the touch display apparatus 200 comprises a substrate 110, a thin film transistor array module (TFT array module) 120, an electrophoretic structure 130, a protective layer 140, a first touch sensing layer 251, a second touch sensing layer 252, a cover plate 160, a light guide plate 170, and a color filter 180, in which the substrate 110, the TFT array module 120, the electrophoretic structure 130, the protective layer 140, the cover plate 160, the light guide plate 170, and the color filter 180 are identical or similar to those of the embodiment demonstrated in FIG. 1. Therefore, relevant explanations of such structures, functions, and connections of these elements can be referenced above and will not be repeated again. In comparison with the embodiment of FIG. 1, the embodiment of FIG. 2 contains modifications of the first touch sensing layer 251 and the second touch sensing layer 252.

In the embodiment, as shown in FIG. 2, the first touch sensing layer 251 and the second touch sensing layer 252 are respectively located on two opposite sides of the protective layer 140. More specifically, the first touch sensing layer 251 is located on one side of the protective layer 140 away from the electrophoretic structure 130, and located between the light guide plate 170 and the cover plate 160. The second touch sensing layer 252 is located between the protective layer 140 and the electrophoretic structure 130. The first touch sensing layer 251 comprises a thin film substrate 251a and a sensing electrode layer 251b. The thin film substrate 251a is located on one side of the organic material layer 141 away from the inorganic material layer 142. The sensing electrode layer 251b is disposed on the thin film substrate 251a and located between the thin film substrate 251a and the organic material layer 141. The second touch sensing layer 252 is in contact with the surface of the inorganic material layer 142 away from the organic material layer 141. The sensing electrode layer 251b of the first touch sensing layer 251 and the second touch sensing layer 252 can comprise light-transmissive conductive material (for instance, ITO) or electrode layers via deposition of silver nano wires (SNW). However, the present disclosure is not limited thereto. For example, the light-transmissive conductive material or SNW can be disposed on the surface of the thin film substrate 251a facing the protective layer 140 and the surface of the inorganic material layer 142 away from the organic material layer 141 through the printing process. Next, the aforementioned light-transmissive conductive material or SNW is formed into patterns as electrodes through a photolithography process or laser lithography, so as to fabricate the sensing electrode layer 251b of the first touch sensing layer 251 and the second touch sensing layer 252. The thin film substrate 251a can be regarded as a film layer for disposing the sensing electrode layer 251b; the protective layer 140 is regarded as a film layer for disposing the second touch sensing layer 252.

In some embodiments, the sensing electrode layer 251b of the first touch sensing layer 251 and the second touch sensing layer 252 are configured on the same side of the protective layer 140 and are both disposed on the surface of the thin film substrate 251a facing the protective layer 140 (that is, the thin film substrate 251a shared by the sensing electrode layer 251b of the first touch sensing layer 251 and the second touch sensing layer 152).

In some embodiments, the sensing electrode layer 251b of the first touch sensing layer 251 and the second touch sensing layer 152 are made of a metal mesh layer. For example, metal material is disposed on the surface of the thin film substrate 251a facing the protective layer 140, and the surface of the inorganic material layer 142 away from the organic material layer 141 through the printing process. Next, the aforementioned metal material is formed into patterns as electrodes through a photolithography process or laser lithography, so as to fabricate the sensing electrode layer 251b of the first touch sensing layer 251 and the second touch sensing layer 252.

In some other embodiments, at least one of the light guide plate 10 or the color filter 180 can be omitted.

According to the embodiments of the present disclosure described above, it is obvious that the protective layer 140, disposed on the electrophoretic structure 130 of the touch display apparatus 100, 200 of the present disclosure, is a composite material that comprises an organic material layer 141 and an inorganic material layer 142, in which the inorganic material layer 142 is closer to the electrophoretic structure 130 than the organic material layer 141 is. Thus, the protective layer 140 of the present disclosure has at least the following advantages: (1) high resistance to penetration, blocking external moisture effectively; (2) low water content rate, preventing the electrophoretic structure 130 from the impact of water vapor within the material; and (3) low reactivity, not prone to oxidation and reduction (redox) reaction during electrode conversion.

Though the present disclosure has been disclosed by means of the aforementioned embodiments, it should not be interpreted to limit the scope, applicability, or configuration of the present disclosure in any way. Those skilled at the art may use any alternative embodiments that are modified or changed without departing from the spirit and scope of the present disclosure and should be included in the appended claims.

### COMPONENT SYMBOL

100,200: touch display apparatus
110: substrate
120: thin film transistor array module (TFT array module)
130: electrophoretic structure
140: protective layer
141: organic material layer
142: inorganic material layer
151,251: first touch sensing layer
152,252: second touch sensing layer
160: cover plate
170: light guide plate
180: color filter
251a: thin film substrate
251b: sensing electrode layer

What is claimed is:

1. A touch display apparatus, comprising
an electrophoretic structure;
a protective layer, disposed on the electrophoretic structure and comprising an organic material layer and an inorganic material layer, wherein the inorganic material layer is located between the electrophoretic structure and the organic material layer, a material of the inorganic material layer comprises silicon dioxide (SiO₂), and a thickness of the inorganic material layer is from 20 nm to 400 nm; and
at least one touch sensing layer, disposed on one side of the protective layer.

2. The touch display apparatus as claimed in claim 1, wherein a material of the organic material layer comprises polyethylene terephthalate (PET), polyimide (PI), polymethyl methacrylate (PMMA), polycarbonate (PC), polyurethane (PU), polyvinyl chloride (PVC), or polycaprolactone (PCL).

3. The touch display apparatus as claimed in claim 1, wherein a thickness of the organic material layer is from 700 nm to 10 μm.

4. The touch display apparatus as claimed in claim 1, wherein the at least one touch sensing layer comprises a first touch sensing layer and a second touch sensing layer, and the first touch sensing layer and the second touch sensing layer are respectively located on two opposite sides of the protective layer.

5. The touch display apparatus as claimed in claim 4, wherein the first touch sensing layer is in contact with one surface of the organic material layer away from the inorganic material layer, and the second touch sensing layer is in contact with one surface of the inorganic material layer away from the organic material layer.

6. The touch display apparatus as claimed in claim 4, wherein the first touch sensing layer comprises:
a thin film substrate, disposed on one side of the organic material layer away from the inorganic material layer; and
a sensing electrode layer, disposed on the thin film substrate and located between the thin film substrate and the organic material layer.

7. The touch display apparatus as claimed in claim 1, further comprising:
a cover plate, disposed on one side of the protective layer away from the electrophoretic structure; and
a light guide plate, disposed between the cover plate and the protective layer.

8. A touch display apparatus, comprising
an electrophoretic structure;
a protective layer, disposed on the electrophoretic structure and comprising an organic material layer and an inorganic material layer, wherein the inorganic material layer is located between the electrophoretic structure and the organic material layer; and
at least one touch sensing layer, disposed on a side of the protective layer, wherein a combination of the protective layer and the at least one touch sensing layer has a light transmittance higher than 85% and a water vapor transmission rate (WVTR) less than 0.01 g/m²·day at 50 degrees Celsius (° C.).

9. The touch display apparatus as claimed in claim 8, wherein a material of the organic material layer comprises polyethylene terephthalate (PET), polyimide (PI), polymethyl methacrylate (PMMA), polycarbonate (PC), polyurethane (PU), polyvinyl chloride (PVC), or polycaprolactone (PCL).

10. The touch display apparatus as claimed in claim 8, wherein a material of the inorganic material layer comprises aluminum oxide (AlOₓ), silicon oxide (SiOₓ), silicon nitride, titanium oxide, zirconium oxide, aluminum oxynitride, silicon oxynitride, or amorphous carbon.

11. The touch display apparatus as claimed in claim 8, wherein a material of the organic material layer comprises polyethylene terephthalate, and a material of the inorganic material layer comprises silicon dioxide (SiO₂).

12. The touch display apparatus as claimed in claim 8, wherein a thickness of the organic material layer is from 700 nm to 10 μm.

13. The touch display apparatus as claimed in claim 8, wherein the at least one touch sensing layer comprises a first touch sensing layer and a second touch sensing layer, and the first touch sensing layer and the second touch sensing layer are respectively located on two opposite sides of the protective layer.

14. The touch display apparatus as claimed in claim 13, wherein the first touch sensing layer is in contact with one surface of the organic material layer away from the inorganic material layer, and the second touch sensing layer is in contact with one surface of the inorganic material layer away from the organic material layer.

15. The touch display apparatus as claimed in claim 13, wherein the first touch sensing layer comprises:
a thin film substrate, disposed on one side of the organic material layer away from the inorganic material layer; and
a sensing electrode layer, disposed on the thin film substrate and located between the thin film substrate and the organic material layer.

16. The touch display apparatus as claimed in claim 8, further comprising:
a cover plate, disposed on one side of the protective layer away from the electrophoretic structure; and
a light guide plate, disposed between the cover plate and the protective layer.
